(19) United States
(12) Patent Application Publication
(10) Pub. No.: US 2023/0074765 A1
(43) Pub. Date: Mar. 9, 2023

(54) LOAD MEASURING ARRANGEMENT AND LOAD MEASURING METHOD FOR MEASURING A LOAD ON A TEST OBJECT HAVING A SECONDARY TRANSMISSION ELEMENT

(71) Applicant: Trafag AG, Bubikon (CH)

(72) Inventors: Tobias Ettenauer, Ostfildern (DE); Philippe Klemm, Stuttgart (DE); Dieter Huber, Männedorf (CH)

(21) Appl. No.: 17/941,091

(22) Filed: Sep. 9, 2022

(30) Foreign Application Priority Data
Sep. 9, 2021 (DE) 10 2021 123 392.5

(51) Int. Cl. G01N 3/06

(52) U.S. Cl. CPC G01N 3/066; G01N 2203/0635; G01N 2203/0274

(57) ABSTRACT

For improving the signal quality while simultaneously improving the function of test objects, a load measuring arrangement includes a test object and a load measuring device for measuring a load applied between a first and a second region of the test object. The test object has a transmission region receiving a major part of the load between the first and the second region. A secondary transmission element is connected to the first and second regions of the test object so as to receive a smaller portion of the load between the first and second regions in parallel with the transmission region. The load measuring device includes a magnetic field generating device for generating a magnetic field at the secondary transmission element, and a magnetic field detection device for detecting a magnetic field parameter changing due to the load at the secondary transmission element.

### CROSS-REFERENCE TO RELATED APPLICATION

This application claims priority from German Application No. 10 2021 123 392.5 filed on Sep. 9, 2021, which is incorporated herein by reference in its entirety.

### TECHNICAL FIELD

The invention relates to a load measuring arrangement comprising a test object and a load measuring device for measuring a load applied between a first region and a second region of the test object by means of active magnetization. Further, the invention relates to a load measuring method for measuring a load applied between a first region of a test object and a second region of a test object by means of active magnetization.

### RELATED ART

Load measuring arrangements and load measuring methods are known in which a load such as a torque, force or even mechanical stresses in a test object are measured magnetostrictively. While some of these measuring methods and measuring arrangements require the measuring zone to be permanently magnetized in advance, the invention relates to such measuring methods and measuring arrangements in which a magnetic field is only actively applied during the measurement and magnetic field parameters, which are present when the measuring zone of the test object located in the magnetic field is subjected to a load, are detected to determine the load.

Such load measuring arrangements and load measuring methods are known from the following literature:
[1] WO 2018/019859
[2] EN 10 2016 117 529 A1
[3] EN 10 2017 107 716 A1
[4] EN 10 2017 109 114 B4
[5] WO 2018/229016
[6] WO 2019/197500
[7] WO 2019/207166
[9] WO 2019/243448 A1
[10] EN 10 2018 120 400 A1
[11] EN 10 2018 120 401 A1
[12] EN 10 2018 124 644 B4
[13] EN 10 2018 120 794 A1
[14] WO 2020/038614 A1
[15] EN 10 2019 102 454 B3
[16] EN 10 2019 108 898 A1
[17] WO 2020/002390 A1

The aforementioned load measuring methods and load measuring arrangements have been proven to measure torques, forces, stresses. However, for some test objects, there are conflicting objectives with respect to the desired function of the test object and the measurement of the load on the test object. For example, it may be desirable to manufacture the test object, such as shafts, chassis components, power transmission elements, gear elements, bicycle parts or the like, from materials and/or in geometries that are optimized in terms of weight, power transmission, adaptation to environmental conditions, stiffness, main function fulfillment, etc., but that are less suitable for magnetostrictive load measurement.

### SUMMARY

The invention is based on the problem of improving load measuring arrangements and load measuring methods of the kind mentioned in literature [1] to [17] with regard to function of the test object and measurement of the load.

To solve this problem, the invention provides a load measuring arrangement and a load measuring method according to the independent claims.

Advantageous embodiments are the subject of the subclaims.

The invention provides a load measuring arrangement comprising a test object and a load measuring device for measuring a load applied between a first region and a second region of the test object, wherein the test object has a main transmission region receiving a majority of the load between the first region and the second region, wherein a secondary transmission element is attached to the first and second regions of the test object so as to receive a smaller portion of the load between the first and second regions in parallel with the main transmission region, the load measuring apparatus comprising magnetic field generating means for generating a magnetic field at the secondary transmission element, and a magnetic field detection device for detecting a magnetic field parameter changing due to the load on the secondary transmission element.

Thus, the material and/or structure of the secondary transmission element can be formed for optimal load measurement, while the transmission region can be formed for optimal functional performance of the test object.

The load measuring device can be designed as described in the aforementioned literature [1] to [17] and thus have, for example, a measuring sensor, such as sensor head with coils, in particular planar coils, more particularly in V or X arrangement, in order to generate a magnetic field by means of a generator coil and to detect magnetic field parameter changes dependent on loads by means of measuring coils.

Accordingly, it is preferred that the load measuring device comprises a first and a second magnetic field detection device for detecting the magnetic field parameter changing due to the load on the secondary transmission element.

It is preferred that the load measuring device comprises a generator coil and at least two measuring coils.

It is preferred that the load measuring device comprises planar coils.

It is preferred that the load measuring device comprises at least three coils arranged in a V-shape or five coils arranged in an X-shape.

It is preferred that the load measuring device comprises a measuring sensor having the magnetic field generating device and the at least one magnetic field detection device, and a supply and evaluation unit connected to the measuring sensor. Preferred further details of the supply and evaluation unit are described in particular in [5], [7] and [17].

The secondary transmission element can be optimally designed for load measurement by active magnetization, in particular with regard to material selection. Preferred materials for the secondary transmission element or at least of a measuring zone thereof are:
ferromagnetic materials
steel with a relative permeability >2
non-ferromagnetic steel which achieves a relative permeability >2 at least locally by plastic deformation
iron with <30% alloying elements, with a relative permeability >2
nickel with <30% alloying elements, with a relative permeability >2
cobalt with <30% alloying elements, with a relative permeability >2
iron-nickel alloys with <30% alloying elements, with a relative permeability >2
iron-cobalt alloys with <30% other alloying elements, with a relative permeability >2
cobalt-nickel alloys with <30% other alloying elements, with a relative permeability >2
iron-cobalt nickel alloys
ferromagnetic nickel alloys with <30% other alloying elements, with a relative permeability >2
ferromagnetic cobalt alloys with <30% other alloying elements, with a relative permeability >2
iron-nickel alloys with <30% other alloying elements, with a relative permeability >2
alloys consisting of at least 70% of the elements iron, cobalt, nickel, manganese and chromium, wherein not all 5 elements need to be included and have a magnetic order (ferromagnetic, ferrimagnetic, antiferromagnetic)
metallic glass with a relative permeability >2
x-ray amorphous metals with a relative permeability >2
ferrites with a relative permeability >2
   manganese-zinc ferrites with <30% other alloying elements, with a relative permeability >2
   nickel-zinc ferrites with <30% other alloying elements, with a relative permeability >2
   strontium ferrites with <30% other alloying elements, with a relative permeability >2
   barium ferrites with <30% other alloying elements, with a relative permeability >2
   cobalt ferrite with <30% other alloying elements, with a relative permeability >2
   magnetite with <30% other alloying elements.
work-hardened metallic materials with residual stresses that are >400 MPa in magnitude and have a permeability >2
   steel
   iron <30% alloying elements
   nickel <30% alloying elements
   cobalt <30% alloying elements
   iron-nickel alloys with <30% other alloying elements
   iron-cobalt alloys with <30% other alloying elements
   cobalt-nickel alloys with <30% other alloying elements
   iron-cobalt-nickel alloys with <30% other alloying elements
metallic glass
with a coating having a permeability >2 where the thickness is >1 μm
   metallic glass
   x-ray amorphous metal
   electroless nickel
   electroplated nickel
   iron, cobalt, nickel alloys with <30% alloy content of other elements
   iron, cobalt, nickel alloys with 0.5<X<30% alloying components from the group of glass formers/network formers (phosphorus, boron, silicon, arsenic, germanium, antimony) and <10% other alloying components.

Preferably, the secondary transmission element can be more easily fabricated separately from any other base body of the test object. For example, a smaller secondary transmission element is easier to handle for material processing or coating than, for example, larger shafts or chassis parts or the like. The secondary transmission element can then be attached to the base body of the test object so that part of the load is received via the secondary transmission element and can be measured there. From this, it is then possible to determine the load on the test object, for example after calibration.

It is preferred that the load measuring device is designed to measure a force, strain, torque or axial stress using an active magnetic sensor system.

It is preferred that the load measuring device comprises a measuring sensor fixedly connected to the test object and having the magnetic field generating device and the at least one magnetic field detection device.

It is preferred that the load measuring device comprises a measuring sensor fixedly connected to the secondary transmission element and having the magnetic field generating device and the at least one magnetic field detecting device.

It is preferred that the secondary transmission element is magnetostrictive and is attached to the first and second regions of the test object such that deformation of the test object results in deformation of the secondary transmission element, wherein the load measuring device is configured to determine the load on the secondary transmission element.

In one embodiment, it is preferred that the secondary transmission element is formed from the same material as the transmission region. This allows measurement errors, for example due to different temperature expansions, to be reduced. By using the secondary transmission element, the geometry of the secondary transmission element can be optimized for load measurement independently of the geometry of the transmission area.

In one embodiment, it is preferred that the secondary transmission element is formed from the same material as the transmission region, but material properties differ due to different heat treatment or different mechanical processing. For example, the secondary transmission element may be subjected to work hardening. Experiments have shown that this can improve load measurements with active magnetization.

It is preferred that the secondary transmission element is coated with a layer of a material with a relative permeability >2.

It is preferred that the secondary transmission element is coated with a layer of a material selected from the group consisting of electroless nickel, nickel, metallic glass, μ-metal, ferrite, permalloy.

It is preferred that the secondary transmission element is fixedly connected to the first region of the test object by a first connecting region and is fixedly connected to the second region of the test object by a second connecting region, wherein a measuring zone of the secondary transmission element arranged between the first and second connecting regions is not connected to the transmission region and is loaded in parallel when the transmission region is loaded, wherein the load measuring device is designed to measure the load on the measuring zone by active magnetization and to determine a magnetic parameter changing due to the load.

It is preferred that the secondary transmission element is connected to the base body of the test object by means of a connection technique selected from the group consisting of rivets, screws, material connection, welding, soldering, bonding, shrinking-on, crimping.

It is preferred that the secondary transmission element is formed, at least at a measuring zone, of a work-hardened metal having a dislocation density >5e8/cm2 or a residual compressive stress >400 MPa in amount.

It is preferred that the measuring zone bridges the first and second connecting regions.

It is preferred that the measuring zone has a smaller thickness and/or width than the connecting regions.

It is preferred that the secondary transfer member is configured with respect to the construction and relative geometry of the connecting regions and the measuring zone such that strain between the first region and the second region of the test object results in greater strain at the measuring zone.

It is preferred that the secondary transmission element is designed with respect to the construction and relative geometry of the connecting regions and the measuring zone such that a strain between the first region and the second region of the test object leads to strain at the measuring zone changed in such a way that an average strain or average stress at a measuring position of the measuring zone, which measuring position extends from a surface facing a measuring sensor of the load measuring device to a depth corresponding to the penetration depth of the magnetic field, deviates by at least 20% from the average strain or average stress of the secondary transmission element.

It is preferred that the connecting regions are formed to be substantially more rigid than the measuring zone.

It is preferred that the first connecting region, the measuring zone and the second connecting region are formed as sleeves which are fastened axially successively to one another and in which the transmission region is accommodated, the connecting regions having a greater wall thickness than the measuring zone, the ends of the connecting regions which are arranged away from one another being fixedly connected to the first and second regions, respectively, of the test object, but relative movements between the sleeves and the transmission region being possible between the first and second regions.

It is preferred that the measuring zone is more elastic than the transmission region.

It is preferred that the test object has an at least piecewise cylindrical surface which is rotatable by at least 5° about the cylinder axis of the cylindrical surface, wherein the secondary transmission element is also at least piecewise cylindrical in shape and is attached to the cylindrical surface of the test object in such a way that it is deformed when loads are applied to the test object, wherein a measuring sensor of the load measuring device which comprises the magnetic field generating device and the at least one magnetic field detection device is arranged such that it does not rotate along with the cylindrical surface when the latter is rotated.

It is preferred that the test object is a shaft for transmitting a torque.

It is preferred that the test object is a gear element for transmitting a force or torque.

It is preferred that the test object is a part of a vehicle or lifting tool loaded in operation.

According to another aspect, the invention provides a load measuring method for measuring a load applied to a test object between a first region and a second region, the test object having a transmission region between the first region and the second region, comprising:
a) attaching a secondary transmission element to the first and second regions in such a manner that a greater portion of the load between the first and second regions is received by the transmission region and, in parallel, a lesser portion of the load is received by the secondary transmission member,
b) magnetizing a measuring zone of the secondary transmission element lying in the force flow of the secondary transmission element, and
c) determining a magnetic field parameter which is dependent on the mechanical load at the measuring zone,
d) determining the load from the determined load-dependent magnetic field parameter.

Preferably, the load measuring arrangement is configured to perform the load measuring method. Preferably, the load measuring method is performed with the load measuring arrangement according to one of the previously described embodiments.

According to a further aspect, the invention provides a manufacturing method of a load measuring arrangement according to one of the previously described embodiments, comprising providing a base body of the test object, providing a secondary transmission element, wherein the secondary transmission element is manufactured and processed separately from the base body, in particular coated, work-hardened or subjected to a heat treatment, attaching a first connecting region of the auxiliary transmission element to the first region of the test object and a second connecting region to the second region of the test object so that the measuring zone of the secondary transmission member located between the first and second connecting regions and the transmission region can move relative to each other for performing different deformations, and arranging the load measuring device for measuring the load at the measuring zone.

Some features and advantages of preferred embodiments of the invention will be explained in more detail below.

Embodiments of the invention relate to load measurement using a secondary transmission element inserted in a secondary force or torque or load flow.

Embodiments of the invention relate to force/strain/axial load measurement using an active magnetic field sensor.

Preferably, a magnetostrictive secondary transmission element (sometimes also referred to as a shunt element) is attached to the measurement object in such a way that a deformation of the measurement object results in a deformation of the secondary transmission element, wherein the determination of the force/strain/load is performed via the secondary transmission element.

Embodiments of the invention relate to a load measuring arrangement on objects having an at least piecewise cylindrical surface that can rotate by at least 5° about the cylinder axis, wherein a likewise at least piecewise cylindrical secondary transmission element is attached to the surface, which transmission element is also deformed by loads on the base body, and wherein the measuring sensor does not follow rotations of the base body.

It is preferred that the secondary transmission element is designed to serve as a signal amplifier, which is preferably achieved by structurally designing it such that strain of the base body results in non-uniform strain in the secondary transmission element, wherein the strain or average stress at the measurement position deviates by at least 20% from the average strain or average stress of the secondary transmission element, wherein the measurement position corresponds to the surface facing the measuring sensor to a depth corresponding to the penetration depth of the magnetic field.

It is preferred in some embodiments that a secondary transmission element is made of the same alloy/steel grade, although the mechanical and heat treatment may differ.

In some embodiments, it is provided that the secondary transmission element is coated with a magnetic (relative permeability >2) layer, in particular electroless nickel, nickel, metallic glass, p-metal, ferrite, permalloy.

Preferably, the secondary transmission element is formed at least in some regions, in particular in a measuring zone, from work-hardened metal (e.g. cold-rolled sheet, deep-drawn cylinder) with a dislocation density >5e8/cm² or a residual compressive stress of greater than 400 MPa in amount.

Preferably, the secondary transmission element is made of μmetal or Metglass.

Preferably, the secondary transmission element is connected to the main body by one of the following attachment methods:
1. rivets
2. screws
3. materially bonded
   a. welding
   b. soldering
   c. gluing
   d. bonding
4. shrinking
5. crimping

In some embodiments, it is provided that the measuring sensor is fixedly connected to the base body. In some embodiments, it is provided that the measuring sensor is fixedly connected to the secondary transmission element.

Some embodiments of the invention relate to a load measuring device comprising a test object and a load measuring device for measuring a load on the test object, wherein the load measuring device comprises a magnetic field detection device for detecting a magnetic field parameter which changes due to load, wherein at least one measuring zone (here on a secondary transmission element of the test object) has been plastically deformed at least in a region from the surface to a depth of 20 μm, at a temperature below the recrystallization temperature, to obtain a dislocation density of at least 5e8/cm².

Accordingly, a preferred embodiment of the manufacturing process comprises plastically deforming at least a measuring zone of the secondary transmission element at least in a region from the surface to a depth of 20 μm, at a temperature below the recrystallization temperature, to obtain a dislocation density of at least 5e8/cm².

Preferably, a near-surface region is or will be plastically deformed using one of the following methods:
1. rolling, e.g.:
   a. ball rolling
   b. smooth rolling
   c. deep rolling
2. blasting, e.g.:
   a. shot blasting
   b. glass bead blasting
   c. ultrasonic blasting
   d. stainless steel blasting
   e. wire shot blasting
   f. sand blasting
   g. ice blasting
   h. high-pressure water blasting
   i. wet blasting
3. laser shock peening
4. denning

In one embodiment, the secondary transmission element is/are made of a previously work-hardened material.

Preferably, the secondary transmission element is/are made of a work-hardened material.

### BRIEF DESCRIPTION OF THE DRAWINGS

Embodiments of the invention will be explained in more detail below with reference to the accompanying drawings wherein it is shown by

FIG. 1 a schematic block diagram of a first embodiment of a load measuring arrangement;

FIG. 2 a schematic block diagram of a second embodiment of the load measuring arrangement;

FIG. 3 a schematic bottom view of a secondary transmission element for a load measuring arrangement according to a further embodiment;

FIG. 4 a schematic sectional view through a load measuring arrangement according to a further embodiment;

FIG. 5 a further schematic sectional view through a further embodiment of a load measuring arrangement;

FIG. 6 a partly sectional, partly perspective view of a test object of the load measuring arrangement of FIG. 5;

FIG. 7 a graph showing the dislocation density versus depth with respect to the surface for a measuring zone of the test object made of a work-hardened material;

FIG. 8 a graph comparable to FIG. 7, where instead of the dislocation density, the compressive residual stress of the work-hardened measuring area is shown over the depth with respect to the surface;

FIG. 9 a graph showing sensor signals on a measuring area of steel 1.4.104 with and without work hardening, here illustrated by shot blasting;

FIG. 10 a graph showing the measurement error for a measurement on a measuring area of steel 1.4104 with and without shot peening, where a measurement error compared to an ideal sensor for measuring areas without shot blasting and with shot blasting of different intensity is illustrated;

FIG. 11 a graph as in FIG. 9, where the measuring zone is formed from steel 1.4112;

FIG. 12 a graph as in FIG. 10, where the measuring zone is formed from steel 1.4112;

FIG. 13 a graph as in FIG. 9, where the measuring zone is formed from steel 1.7227;

FIG. 14 a graph as in FIG. 10, wherein the measuring zone is formed from steel 1.7227;

### DETAILED DESCRIPTION

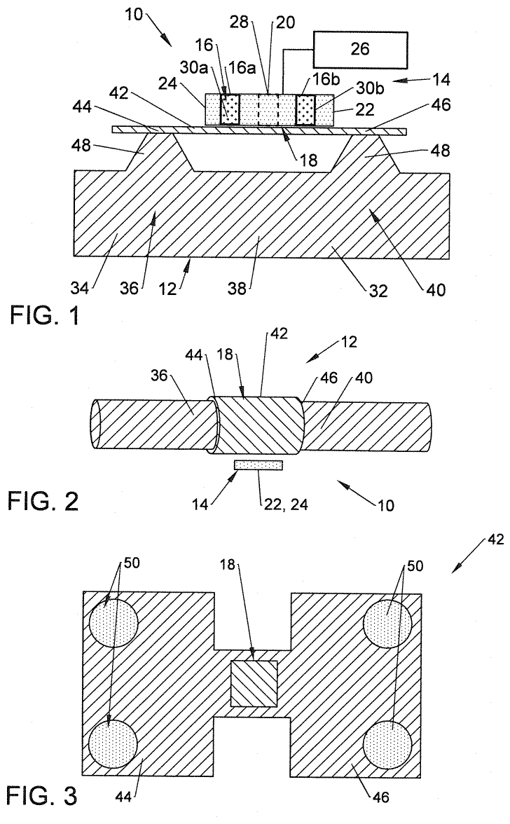

FIGS. 1, 2, 4 and 5 show different embodiments of a load measuring arrangement 10 comprising a test object 12 and a load measuring device 14 for measuring a load on the test object 12.

The load measuring device 14 has at least one magnetic field detecting device 16, 16a, 16b for measuring a magnetic field parameter changing due to stresses in a measuring zone 18 of the test object 12.

Further, the load measuring device 14 has a magnetic field generating device 20 with which a magnetic field is actively generated in the measuring zone 18. This means that the measuring zone 18 does not itself have to be permanently magnetized.

As indicated in FIG. 1, the load measuring device 14 has a measuring sensor 24 designed, for example, as a sensor head 22, and a supply and evaluation unit 26. The measuring sensor 24 has coils designed as planar coils in the form of a generator coil 28 for forming the magnetic field generating device 20 and in the form of a first measuring coil 30a for forming a first magnetic field detecting device 16a and a second measuring coil 30b for forming a second magnetic field detecting device 16b. Concrete possible embodiments of the load measuring device 14 including the sensor head 22 and the supply and evaluation unit 26 can be taken from literature references [1] to [17] mentioned at the beginning.

The test object 12 or the measurement object 32 is, for example, a shaft, a chassis component, a power transmission element, a transmission element, a bicycle crank or any other element on which a load, such as a force, mechanical stress, torque is to be measured.

The measurement object 32 has a base body 34 with a first region 36, a transmission region 38 and a second region 40. Between the first region 36 and the second region 40, the load to be measured is applied. The first region 36 is, for example, an input region, such as an input end of a shaft or an input region of an area of interest of the measurement object 32 with respect to the load to be measured. The second region 40 is, for example, an output end of a shaft or an output region of an area of interest of the measurement object 32 with respect to the load to be measured. The transmission region 38 connects the first region 36 to the second region 40, such that the majority of the load is received by the transmission region 38. The base body 34 and, in particular, the transmission region 38 are configured to be optimized with respect to the function that the measurement object 32 is intended to perform. In particular, the base body 34 and the transmission region 38 need not be formed of a material which is optimized or even formed for magnetostrictive load measurement. For example, the base body 34 could be formed of fiber-reinforced materials, non-metals, or metals with no magnetic properties or only poor magnetic properties. If a base body 34 of steel is selected, the steel grade need not be selected for magnetostrictive properties or machined or coated.

The test object 12 further comprises the secondary transmission element 42, which is subject to load parallel to the transmission region 38 and receives a smaller portion of the load between the first region 36 and the second region 40. The secondary transmission element 42 and the transmission region 38 are not connected to each other, so that local relative displacements between the secondary transmission element 42 and the transmission region 38 are possible and, in particular, locally different deformations of the transmission region 38 and the secondary transmission element 42 are possible.

The measuring zone 18 is formed on the secondary transmission element 42. The secondary transmission element 42 is optimized with respect to design and material selection and/or material processing with respect to magnetostrictive load measurement substantially independently of the base body 34.

In particular with respect to material selection, the secondary transmission element 42 can be optimally formed for load measurement by active magnetization. Preferred materials for the secondary transmission element 42 or at least of the measuring area 18 thereof are:
ferromagnetic materials
steel with a relative permeability >2
non-ferromagnetic steel which achieves a relative permeability >2 at least locally by plastic deformation
iron with <30% alloying elements, with a relative permeability >2
nickel with <30% alloying elements, with a relative permeability >2
cobalt with <30% alloying elements, with a relative permeability >2
iron-nickel alloys with <30% alloying elements, with a relative permeability >2
iron-cobalt alloys with <30% other alloying elements, with a relative permeability >2
cobalt-nickel alloys with <30% other alloying elements, with a relative permeability >2
iron-cobalt nickel alloys
ferromagnetic nickel alloys with <30% other alloying elements, with a relative permeability >2
ferromagnetic cobalt alloys with <30% other alloying elements, with a relative permeability >2
iron-nickel alloys with <30% other alloying elements, with a relative permeability >2
alloys consisting of at least 70% of the elements iron, cobalt, nickel, manganese and chromium, wherein not all 5 elements need to be included and have a magnetic order (ferromagnetic, ferrimagnetic, antiferromagnetic)
metallic glass with a relative permeability >2
x-ray amorphous metals with a relative permeability >2
ferrites with a relative permeability >2
   manganese-zinc ferrites with <30% other alloying elements, with a relative permeability >2
   nickel-zinc ferrites with <30% other alloying elements, with a relative permeability >2
   strontium ferrites with <30% other alloying elements, with a relative permeability >2
   barium ferrites with <30% other alloying elements, with a relative permeability >2
   cobalt ferrite with <30% other alloying elements, with a relative permeability >2
   magnetite with <30% other alloying elements.
work-hardened metallic materials with residual stresses that are >400 MPa in amount and have a permeability >2
   steel
   iron <30% alloying elements
   nickel <30% alloying elements
   cobalt <30% alloying elements
   iron-nickel alloys with <30% other alloying elements
   iron-cobalt alloys with <30% other alloying elements
   cobalt-nickel alloys with <30% other alloying elements
   iron-cobalt-nickel alloys with <30% other alloying elements
metallic glass
with a coating having a permeability >2 where the thickness is >1 μm
   metallic glass
   x-ray amorphous metal
   electroless nickel
   electroplated nickel
   iron, cobalt, nickel alloys with <30% alloy content of other elements
   iron, cobalt, nickel alloys with 0.5<X<30% alloying components from the group of glass formers/network formers (phosphorus, boron, silicon, arsenic, germanium, antimony) and <10% other alloying components.

The secondary transmission element 42 has a first connecting region 44, the measuring zone 18 and a second connecting region 46. The first connecting region 44 attaches the secondary transmission element 42 to the first region 36 of the base body 34. With the second connecting region 46, the secondary transmission element 42 is attached to the second region 40 of the base body 34. Possible fastening methods for fastening the connecting regions 44, 46 to the regions 36, 40 of the base body 34 are:
1. rivets
2. screws
3. materially bonded
a. welding
b. soldering
c. gluing
d. bonding
4. shrinking
5. crimping

FIG. 1 shows a first embodiment of the load measuring arrangement 10. The base body 34 has projections or cantilevers 48 at the first region 36 and the second region 40, the free ends of which are connected to the connecting regions 44, 46 of the secondary transmission element 42. The secondary transmission element 42 is placed over and connected to these cantilevers 48 in a bridge-like manner. In this embodiment, the measuring sensor 24 is fixedly connected to the secondary transmission element 42. In a variant not shown, the measuring sensor 24 is fixedly connected to the base body 34, for example below the secondary transmission element 42. When a load, such as torque or force, is applied between the left end and the right end of the base body 34, a major part of this force is passed through the transmission region 38, while a smaller portion is introduced into the secondary transmission element 42 through the cantilevers 48 and the connecting regions 44, 46. Thus, if the base body 34 is deformed by the load, for example, then the secondary transmission element 42 is also deformed. The stresses that occur as a result in the secondary transmission element 42 can be detected magnetostrictively and are a measure of the load applied to the base body 34.

As the embodiment of FIG. 2 shows, the base body 34 can also be at least partially cylindrical in shape, with the secondary transmission element 42 also being at least partially cylindrical in shape. In the embodiment shown in FIG. 2, the measurement object 32 is a shaft with a cylindrical shape. The secondary transmission element 42 is formed as a sleeve which is slipped over the shaft. The two ends of the sleeve forming the secondary transmission element 42 are connected to the base body 34 and thus form the connecting regions 44, 46. The inner side of the sleeve forming the secondary transmission element 42 is either formed at a distance from the outer side of the transmission region 38 covered by the sleeve here or rests thereon in a sliding manner.

FIG. 3 shows an embodiment of the secondary transmission element 42 formed to serve as a signal amplifier. The secondary transmission element 42 is formed such that stresses generated by a relative movement of the connecting regions 44, 46 are concentrated in the measuring zone 18. For example, the connecting regions 44, 46, shown here with contact points 50, for example welding points, are formed of a thicker material or are substantially larger in width than the measuring zone 18. The design is such that stress is concentrated at that surface of the measuring zone 18 which faces the measuring sensor 24. This can be achieved by appropriate thicknesses and transitions between the connecting regions 44, 46 and the measuring zone 18. The design is selected such that the voltage in the near-surface region of the measuring zone 18 is at least 20 percent higher than the average voltage between the contact points 50 of the first and second connecting regions 44, 46.

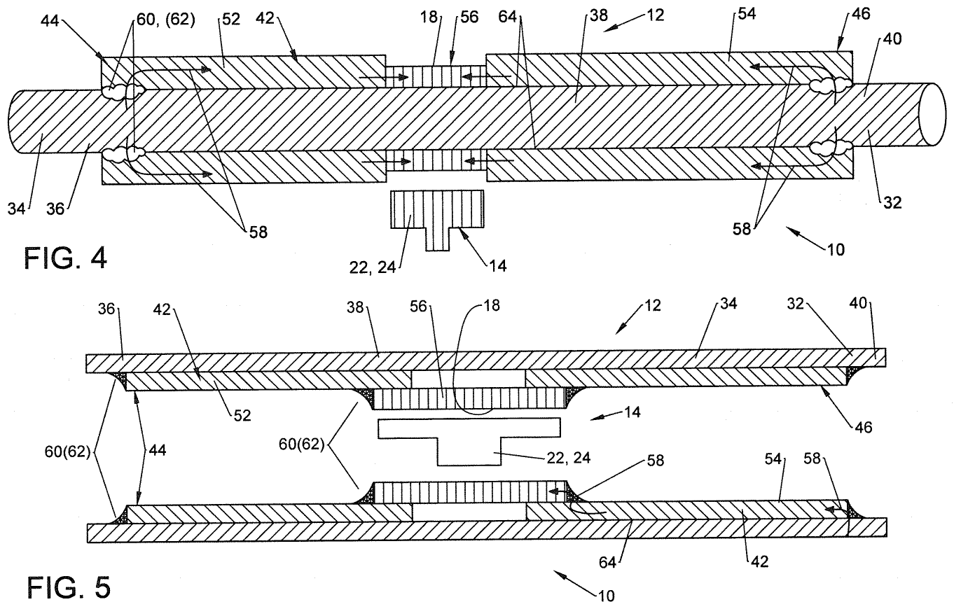

FIG. 4 shows another possible embodiment of the load measuring arrangement 10, in which the secondary transmission element 42 is designed for signal amplification. The first connecting region 44 is formed at a first end of a first sleeve 52, and the second connecting region 46 is formed at the opposite end of a second sleeve 54. The two ends of the sleeves 52, 54 facing each other are connected to a measuring zone sleeve 56 having a wall thickness substantially less than the wall thickness of the first and second sleeves 52, 54. The main body 34 is designed as a solid shaft.

In the embodiment of FIG. 4, the sleeves 52, 54, 56 are arranged externally around the transmission region 38 designed as a solid shaft, with sliding surfaces 64 being located between the inside of the sleeves 52, 54, 56 and the outside of the transmission region 38, so that relative rotations between the measuring zone sleeve 56, which is designed as a measuring tube, and the transmission region 38 are possible. The transmission region 38 can thus be uniformly loaded, while deformation is concentrated in the secondary transmission element 42 at the measuring zone sleeve 56.

Further, the force flow 58 of the load on the secondary transmission element 42 is shown when a torque is transmitted via the solid shaft—measurement object 32. The arrangement of FIG. 4 shows a main transmission of torque via the transmission region 38 and a secondary transmission of force via the secondary transmission element 42 with a torsional amplification to enable rotating torque measurement. The transducer 24, designed as a sensor head 22, is stationary in the region radially outside the measuring zone sleeve 56. When the measurement object 32 is rotated, the measuring zone sleeve 56 rotates relative to the sensor head 22. The connection of the connecting regions 44, 46 with the regions 36, 40 of the measurement object 32 are fixedly connected by a weld 60 or a solder joint 62. The first and second sleeves 52, 54 are designed as stiff tubes for rotation feedback and slide with sliding surfaces 64 on the outside of the transmission region 38. That is, the first and second sleeves 52, 54 are much stiffer than the measuring zone sleeve 56.

With this design, the full angle of rotation that is created across the solid shaft carrying the main force can be conveyed to the measurement tube by means of two welded or soldered stiff tubes. The measurement tube can be designed to utilize the full safety factor margin.

The measurement tube—measuring zone sleeve 56—is designed to be more elastic than the solid shaft so that only a fraction of the total torque is introduced into the measurement tube.

FIG. 5 shows a further embodiment of the load measuring arrangement 10, which operates on a similar principle as the embodiment shown in FIG. 4. Here, however, the first and second sleeves 52, 54, as well as the measuring zone sleeve 56 are not formed on the outside of the base body 34; rather, the base body 34 is formed as a torsion tube, with the sleeves 52, 54, 56 being arranged on an inner side thereof and thus inside the torsion tube. The measuring sensor 24/sensor head 22 is also located inside. This design is suitable, for example, for chassis components, such as roll stabilizers or the like, in which torques or other loads may be transmitted via a tubular element, in an environment where harsh conditions may prevail. As can be seen from the illustration in FIG. 5, instead of being arranged axially between the first and second sleeves 52, 54, the measuring zone sleeve 56 can also be arranged radially offset, resting on circumferential surfaces of the sleeves 52, 54. Otherwise, the design and function of the embodiment shown in FIG. 5 correspond to that of FIG. 4.

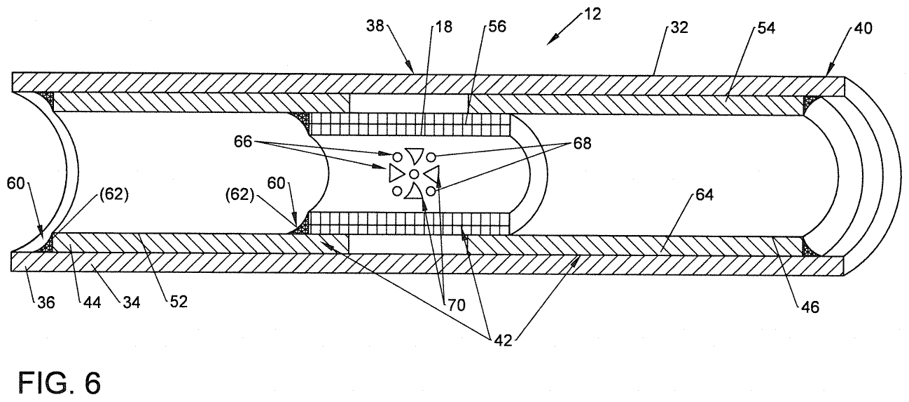

As can be seen from the illustration in FIG. 6, the secondary transmission element 42 can also have recesses 66 formed here, for example, by bores or round openings 68 and triangular through-openings 70 or also blind recesses in order to locally concentrate stresses in the measuring zone 18 occurring during a relative rotation of the connecting regions 44, 46.

In particularly preferred embodiments, at least the measuring zone 18, in this case in particular the near-surface region from the surface facing the measuring sensor 24 to a depth of about 20 μm, is work-hardened.

This can be done, for example, by local mechanical work-hardening. According to embodiments, the near-surface regions of at least the measuring zone 18 of the secondary transmission element 42 is plastically work-hardened using one of the following methods:
1 rolling, e.g.:
   a. ball rolling
   b. smooth rolling
   c. deep rolling
2. blasting, e.g.:
   a. shot blasting
   b. glass bead blasting
   c. ultrasonic blasting
   d. stainless steel blasting
   e. wire shot blasting
   f. sand blasting
   g. ice blasting
   h. high-pressure water blasting
   i. wet blasting
3. laser shock peening
4. denning

In another possible embodiment, a material such as a metal sheet is first provided from one of the above possible materials and is correspondingly plastically cold-formed, and the test object 12 or the secondary transmission element 42 is then produced from this material, for example by punching.

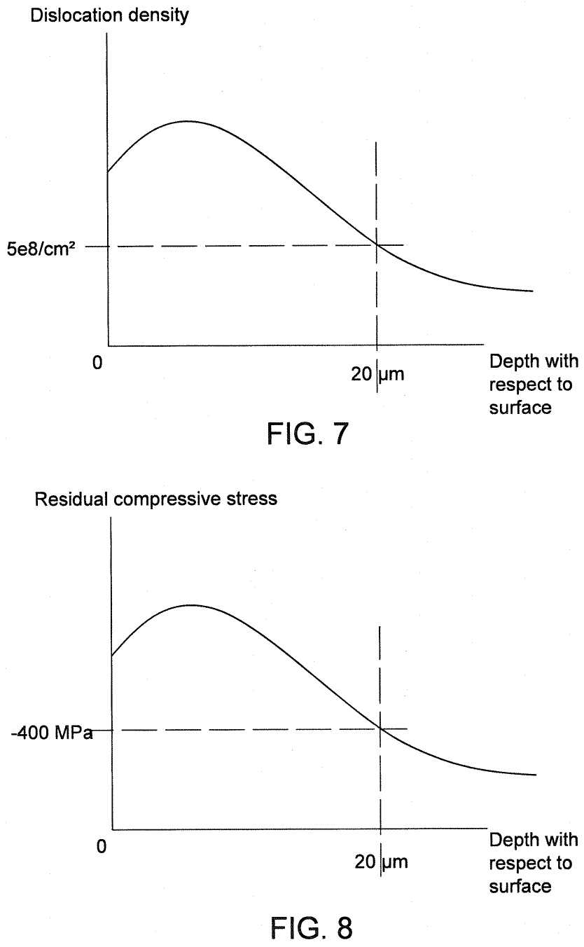

FIG. 7 shows the dislocation density, highlighted in the material and obtained by one of the above-mentioned machining processes, plotted versus depth, where 0 represents the position of the surface. Machining is carried out so that the dislocation density in the near-surface region 52 to 20 μm amounts to at least 5e8/cm2. FIG. 8 shows the residual compressive stress of a material machined in this way. This is such that the residual compressive stress is, in amount, at least 400 MPa in the region between the surface and a depth up to at least 20 μm.

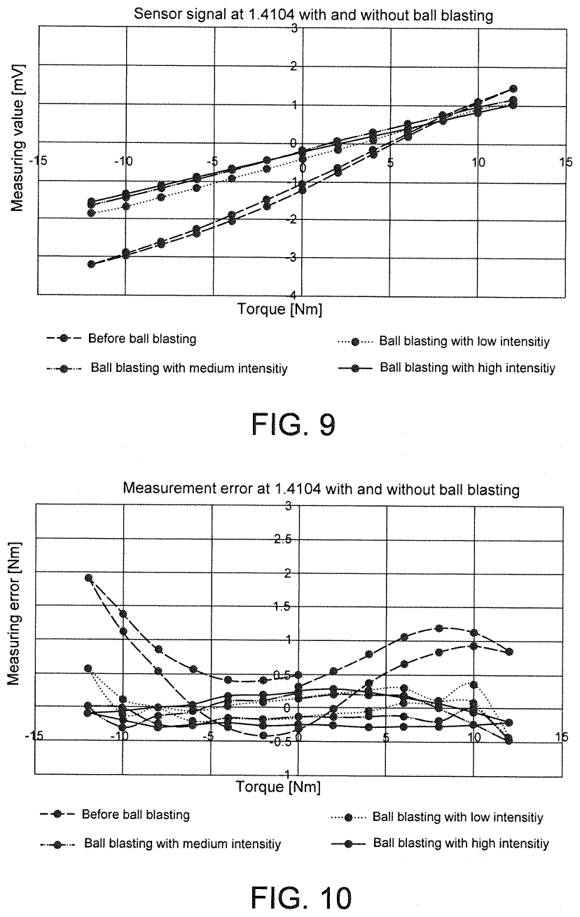

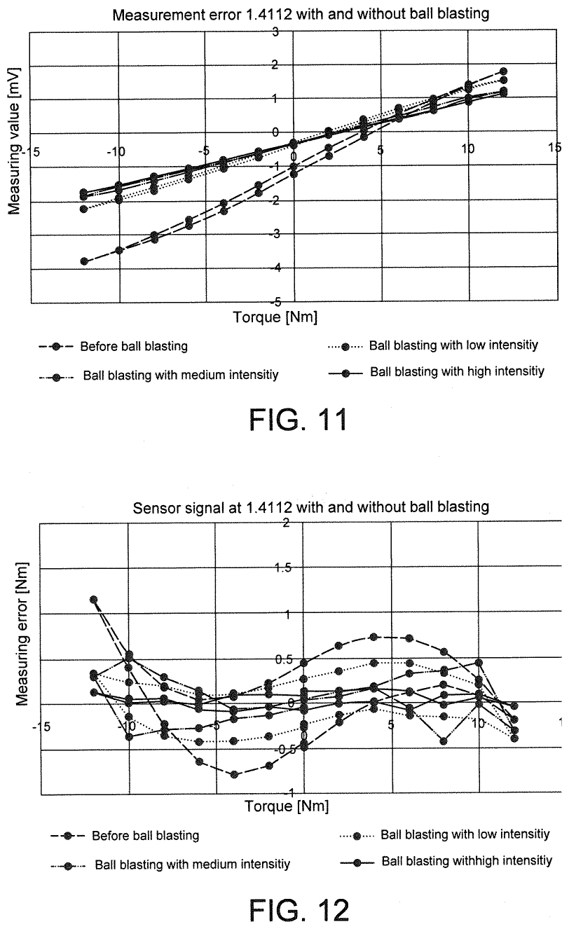

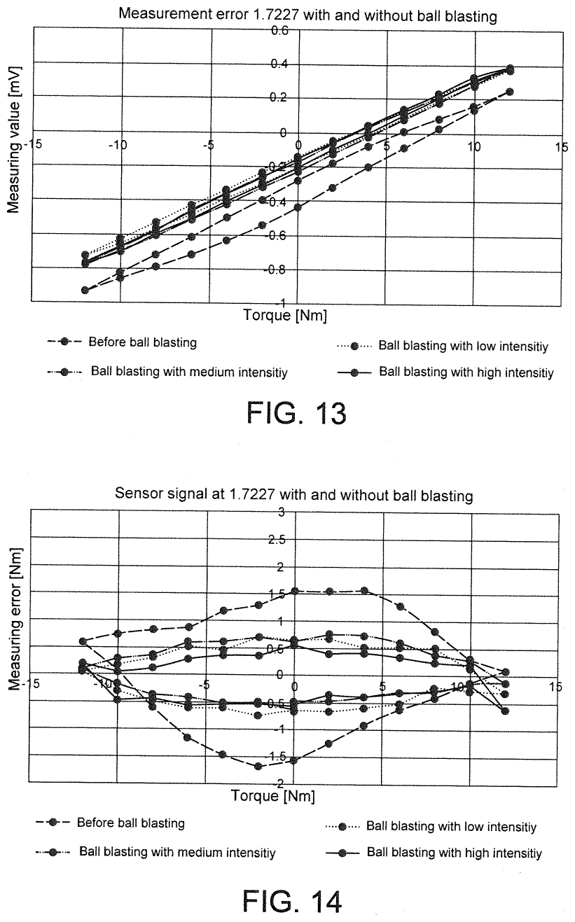

FIG. 9 uses the example of the material steel 1.4104 to illustrate the influence of work hardening using shot blasting with different intensities. While a test object 12 whose measuring zone 18 has not been shot blasted shows significant deviations from an ideal characteristic curve which passes linearly through the zero point, measured values on test objects 12 with shot blasting approach the ideal line. FIG. 10 shows the measurement deviation from the ideal sensor for a test object 12 with a measuring zone 18 of steel 1.4104 with and without shot blasting. Here, too, it can be seen that the measured values improve significantly for a measuring zone 18 with cold deformation compared to the unmachined material. FIGS. 11 and 12 show comparable graphs to FIG. 9 and FIG. 10 for steel 1.4112 to form the measuring zone 18; and FIGS. 13 and 14 show the corresponding graphs for steel 1.7227 as the material for the measuring zone 18.

As can be seen from these examples, the effect of cold deformation is present for different materials.

### LIST OF REFERENCE SIGNS

10 load measuring arrangement
12 test object
14 load measuring device
16 magnetic field detection device (16a, 16b)
16a first magnetic field detection device (16a, 16b)
16b second magnetic field detection device (16a, 16b)
18 measuring zone
20 magnetic field generating device
22 sensor head
24 measuring sensor
26 supply and evaluation unit
28 generator coil
30a first measuring coil
30b second measuring coil
32 measurement object
34 base body
36 first region
38 transmission region
40 second region
42 secondary transmission element
44 first connecting region
46 second connecting region
48 cantilever
50 contact points
52 first sleeve
54 second sleeve
56 measuring zone sleeve
58 force flow
60 welding
62 solder joint
64 sliding surface
66 recess
68 round opening
70 triangular through opening

1. A load measuring arrangement comprising a test object and a load measuring device for measuring a load applied between a first and a second regions of the test object, the test object having a transmission region which receives a major part of the load between the first and second regions, wherein a secondary transmission element is attached to the first and second regions of the test object such that it receives a smaller portion of the load between the first and second regions parallel to the transmission region, the load measuring device comprising a magnetic field generating device for generating a magnetic field at the secondary transmission element and a magnetic field detection device for detecting a magnetic field parameter changing due to the load at the secondary transmission element.

2. The load measuring arrangement according to claim 1, characterized by at least one or more of the following features:
that the load measuring device
2.1 comprises a first and a second magnetic field detection device for detecting the magnetic field parameter changing due to the load at the secondary transmission element;
2.2 comprises a generator coil and at least two measuring coils;
2.3 comprises planar coils;
2.4 comprises at least three coils arranged in a V-shape or five coils arranged in an X-shape; or
2.5 comprises a measuring sensor having the magnetic field generating device and the at least one magnetic field detection device and a supply and evaluation unit connected to the measuring sensor.

3. The load measuring arrangement according to claim 1, characterized in that the secondary transmission element is formed at least partially from a material of the group consisting of
ferromagnetic material,
steel with a relative permeability >2,
non-ferromagnetic steel which achieves a relative permeability >2 at least locally by plastic deformation,
iron with <30% alloying elements and with a relative permeability >2,
nickel with <30% alloying elements and with a relative permeability >2,
cobalt with <30% alloying elements and with a relative permeability >2,
an iron-nickel alloy with <30% alloying elements and with a relative permeability >2,
an iron-cobalt alloy with <30% other alloying elements and with a relative permeability >2,
a cobalt-nickel alloy with <30% other alloying elements and with a relative permeability >2,
an iron-cobalt-nickel alloy,
a ferromagnetic nickel alloy with <30% other alloying elements and with a relative permeability >2,
a ferromagnetic cobalt alloy with <30% other alloying elements and with a relative permeability >2,
an iron-nickel alloy with <30% other alloying elements and with a relative permeability >2,
an alloy consisting of at least 70% of the elements iron, cobalt, nickel, manganese and chromium, wherein not all 5 elements need to be included and have a magnetic order (ferromagnetic, ferrimagnetic, antiferromagnetic)
a metallic glass with a relative permeability >2,
an x-ray amorphous metal with a relative permeability >2,
ferrites with a relative permeability >2,
manganese-zinc ferrites with <30% other alloying elements and with a relative permeability >2,
nickel-zinc-ferrites with <30% other alloying elements and with a relative permeability >2,
strontium ferrites with <30% other alloying elements and with a relative permeability >2,
barium ferrites with <30% other alloying elements and with a relative permeability >2,
cobalt ferrites with <30% other alloying elements and with a relative permeability >2,
magnetite with <30% other alloying elements,
a work-hardened metallic material with a residual stress that is >400 MPa and with a permeability >2,
cold-worked steel with a residual stress that is >400 MPa,
cold-worked iron with a residual stress that is >400 MPa, with <30% alloying elements,
cold-worked nickel with a residual stress that is >400 MPa, with <30% alloying elements,
cold-worked cobalt with a residual stress that is >400 MPa, with <30% alloying elements,
cold-worked iron-nickel alloy with a residual stress that is >400 MPa, with <30% other alloying elements,
cold-worked iron-cobalt alloy with a residual stress that is >400 MPa, with <30% other alloying elements,
cold-worked cobalt-nickel alloy with a residual stress that is >400 MPa, with <30% other alloying elements,
cold-worked iron-cobalt-nickel alloy with <30% other alloying elements,
metallic glass,
a material with a coating having a permeability >2 and a thickness >1 μm,
a material with a coating of x-ray amorphous metal and a relative permeability >2,
a material with a coating of metallic glass,
a material with a coating of electroless nickel,
a material with a coating of electroplated nickel,
a material with a coating of iron-cobalt-nickel alloys with <30% alloy content of other elements, and
an iron-cobalt-nickel alloy with 0.5<X<30% alloying components from the group of glass formers/network formers, in particular phosphorus, boron, silicon, arsenic, germanium, antimony, and <10% other alloying components.

4. The load measuring arrangement according to claim 1, characterized by at least one or more of the following features:
that the load measuring device
4.1 is configured to measure a force, a strain, a torque or an axial stress with the aid of an active magnetic sensor system;
4.2 includes a measuring sensor which is fixedly connected to the test object and has the magnetic field generating device and the at least one magnetic field detection device; or
4.3 includes a measuring sensor which is fixedly connected to the secondary transmission element and has the magnetic field generating device and the at least one magnetic field detection device.

5. The load measuring arrangement according to claim 1, characterized by at least one or more of the following features:
that the secondary transmission element
5.1 is magnetostrictive and is attached to the first and second regions of the test object in such a way that a deformation of a base body of the test object leads to a deformation of the secondary transmission element, the load measuring device being configured to determine the load at the secondary transmission element;
5.2 is formed from the same material as the transmission element;
5.3 is formed from the same material as the transmission region, but material properties differ due to different heat treatment or different mechanical processing;
5.4 is coated with a layer of a material having a relative permeability >2;
5.5 is coated with a layer of a material selected from the group consisting of electroless nickel, nickel, metallic glass, μ-metal, ferrite, and permalloy;
5.6 is fixedly connected with a first connecting region to the first region of the test object and is fixedly connected with a second connecting region to the second region of the test object, wherein a measuring zone of the secondary transmission element arranged between the first and second connecting regions is not connected to the transmission region and is loaded in parallel when the transmission region is loaded, wherein the load measuring device is configured to measure the load on the measuring zone by active magnetization and to determine a magnetic parameter which changes as a result of the load;
5.7 is connected to the first and second regions of the test object by a connection technique selected from the group consisting of riveting, screwing, material connection, welding, soldering, gluing, bonding, shrinking-on, and crimping; or
5.8 is formed at least at a measuring zone from a work-hardened metal with a dislocation density >5e8/cm² or a compressive residual stress of magnitude >400 MPa.

6. The load measuring device according to claim 5, characterized by at least one or more of the following features:
6.1 that the measuring zone connects the first and second connecting regions in a bridge-like manner;
6.2 that the measuring zone has a smaller thickness and/or width than the first and second connecting regions;
6.3 that the secondary transmission element is configured based on the construction and relative geometry of the first and second connecting regions and the measuring zone in such a way that a strain between the first region and the second region of the test object leads to a greater strain at the measuring zone;
6.4 that the secondary transmission element is configured based on the construction and relative geometry of the first and second connecting regions and the measuring zone in such a way that a strain between the first region and the second region of the test object leads to a strain at the measuring zone changed in such a way that an average strain or average stress at a measuring position of the measuring zone, which measuring position extends from a surface facing a measuring sensor of the load measuring device to a depth corresponding to the penetration depth of the magnetic field, differs by at least 20% from the average strain or average stress of the secondary transmission element;
6.5 that the first and second connecting regions are formed to be substantially more rigid than the measuring zone;
6.6 that the first connecting region, the measuring zone and the second connecting region are configured as sleeves which are fastened to one another in axial succession and in which the transmission region is accommodated, the first and second connecting regions having a greater wall thickness than the measuring zone, the ends of the first and second connecting regions which are arranged away from one another being connected to the first or second region of the test object, but relative movements between the sleeves and the transmission region being possible between the first and second regions; or
6.7 that the measuring zone is more elastic than the transmission region.

7. The load measuring arrangement according to claim 1, characterized by at least one or more of the following features:
that the test object
7.1 has an at least piecewise cylindrical surface which is rotatable by at least 5° about the cylinder axis of the cylindrical surface, wherein the secondary transmission element is likewise at least piecewise cylindrical and is attached to the cylindrical surface of the test object in such a way that it is deformed when loads are applied to the test object, wherein a sensor of the load measuring device, which comprises the magnetic field generating device and the at least one magnetic field detection device, is arranged in such a way that it does not rotate along with the cylindrical surface when the latter is rotated;
7.2 is a shaft for transmitting a torque;
7.3 is a gear element for transmitting a force or torque; or
7.4 is a part of a vehicle or lifting tool loaded in operation.

8. A load measuring method for measuring a load applied to a test object between a first and a second region, the test object having a transmission region between the first and second regions, comprising:
a) attaching a secondary transmission element to the first and second regions such that a greater portion of the load between the first and second regions is received through the transmission region and a lesser portion of the load is received in parallel through the secondary transmission element;
b) magnetizing a measuring zone of the secondary transmission element lying in the force flow of the secondary transmission element;
c) determining a magnetic field parameter which is dependent on the mechanical load at the measuring zone; and
d) determining the load from the determined load-dependent magnetic field parameter.

9. The load measuring method according to claim 8, carried out with a load measurement arrangement comprising a test object and a load measuring device for measuring a load applied between a first and a second regions of the test object, the test object having a transmission region which receives a major part of the load between the first and second regions, wherein a secondary transmission element is attached to the first and second regions of the test object such that it receives a smaller portion of the load between the first and second regions parallel to the transmission region, the load measuring device comprising a magnetic field generating device for generating a magnetic field at the secondary transmission element and a magnetic field detection device for detecting a magnetic field parameter changing due to the load at the secondary transmission element.

10. A manufacturing method for manufacturing the load measuring arrangement according to claim 1, comprising:
providing a base body of the test object;
providing a secondary transmission element, wherein the secondary transmission element is manufactured and processed by at least one of coating, work-hardening, or subjecting to a heat treatment, separately from the base body;
fixing a first connecting region of the secondary transmission element to the first region of the test body and a second connecting region to the second region of the test body so that the measuring zone of the secondary transmission element located between the first and second connecting regions, and the transmission region are capable of moving relative to each other for performing different deformations; and
arranging the load measuring device for measuring the load at the measuring portion.
